(19) United States
(12) Patent Application Publication
(10) Pub. No.: US 2008/0237263 A1
(43) Pub. Date: Oct. 2, 2008

(54) Liquid Dispenser with Reservoir and Pump Attaching Mechanism

(76) Inventors: Jonathan Green, Warlingham (GB); Peter J. Oliver, Warlingham (GB)

Correspondence Address: DORITY & MANNING, P.A., POST OFFICE BOX 1449, GREENVILLE, SC, 29602-1449, US

(21) Appl. No.: 11/693,021

(22) Filed: Mar. 29, 2007

(51) Int. Cl. B67D 5/00

(52) U.S. Cl. 222/153.13

(57) ABSTRACT

A dispenser for dispensing a metered dose of foam or liquid from a reservoir, includes a housing, and a replaceable liquid reservoir seated within the housing. A pump mechanism is attached to the reservoir and includes a dispensing nozzle oriented to dispense the metered dose from the reservoir upon actuation of the dispenser by a user. The pump mechanism is attached to a neck of the reservoir with a locking mechanism configured to engage and lock the pump mechanism at a desired position relative to the neck. The locking mechanism may also prevent subsequent removal of the pump mechanism from the neck.

### TECHNICAL FIELD

The present invention relates generally to liquid soap dispensers that utilize a disposable soap container.

### BACKGROUND OF THE INVENTION

Various types of dispensers are known for dispensing liquid soap from a container as a metered dose of liquid or foam. These dispensers are typically used in public restroom facilities, hospitals and other healthcare facilities, food service establishments, and so forth. A number of the known dispensers utilize a housing that mounts onto a wall or other support surface, with the housing containing a replaceable liquid soap reservoir or container, such as a collapsible bag, bottle, or other type of disposable container. A pump mechanism is configured with the housing and mates with a dispensing neck of the soap container once the container has been properly seated in the housing. The pump mechanism is a permanent fixture of the housing and is not considered a disposable item. Examples of the above-described type of soap dispenser are disclosed, for example, in the following U.S. patents and published application: U.S. Pat. No. 7,066,356; U.S. Pat. No. 6,758,372; U.S. Pat. No. 5,732,853; U.S. Pat. No. 5,556,005; and US Pub. No. 2005/0072805.

Certain inherent drawbacks exist with the type of dispenser described in the above-cited publications. For example, because the pump mechanism is not replaceable, any malfunction of the pump renders the entire dispenser useless. The pump is susceptible to vandalism and abuse, particularly in public restroom facilities, and any malfunction that deprives users of use of the pump creates unsanitary conditions. Also, the pump mechanism must be designed for a countless number of operating cycles over the expected useful life of the dispenser, resulting in relatively expensive pump components.

Recently, dispensers have been introduced in the industry wherein the pump mechanism is a component of the disposable soap container. Economies of scale and improvements in pump components have made this type of dispenser a viable alternative. Examples of such dispensers are commercially available from, for example, Bentfield Europe B.V. of The Netherlands, or described for example in the PCT publication WO 03/041871. With this dispenser, the disposable liquid reservoir is filled with a liquid soap, and the pump mechanism (with dispensing nozzle) is subsequently attached to the reservoir, typically by screwing the pump mechanism onto a threaded neck component of the reservoir. The reservoir with attached pump mechanism may then be placed into a housing that is specifically designed to accommodate the unit, with the housing having an actuating member (i.e., a push panel or lever) that engages the pump mechanism.

An important consideration with the disposable reservoir and pump mechanism combination is the alignment between the pump and the reservoir. This alignment must be relatively exact to ensure that the dispensing nozzle of the pump is properly oriented for dispensing soap from the dispenser housing at the desired angle. In this regard, the WO '871 publication teaches that the pump mechanism is screwed onto a “coupling piece” that is then pushed or screwed onto a neck or “plug” of the reservoir. The reference describes that “guidance means” can be used to align the pump, coupling piece, and plug at the correct relative angles. The pump is attached to the housing with an adapter that engages the coupling piece to ensure proper orientation of the pump nozzle relative to the housing.

The present invention relates to an improved and simplified construction for mounting the pump mechanism to a disposable reservoir that offers distinct advantages over the prior art configurations.

### SUMMARY OF THE INVENTION

Objects and advantages of the invention will be set forth in part in the following description, or may be obvious from the description, or may be learned through practice of the invention.

A dispenser is provided for dispensing a metered dose of foam or liquid from a reservoir. Although having particular usefulness as a soap dispenser wherein liquid soap is dispensed as foam or a liquid, it should be appreciated that the dispenser according to the invention may be utilized to dispense any desired liquid or foam. For example, the dispenser may be used to dispense food condiments, lotions, disinfectants, and so forth. The inventive dispenser is not limited by its intended use.

The dispenser includes a housing having any desired shape and configuration. The housing defines an internal cavity for receipt of a replaceable liquid reservoir. This reservoir may be, for example, a bag, a rigid wall container, a collapsible wall container, and the like. The reservoir may be vented, or non-vented and collapsible.

A pump mechanism is attached to the reservoir and includes a dispensing nozzle oriented to dispense the metered dose of foam or liquid from the reservoir upon actuation of the dispenser by a user. The dispenser is not limited to any particular type of pump mechanism, and any number of commercially available pumps may be utilized. The pump mechanism may dispense metered doses of liquid from the reservoir, or include an internal foaming mechanism that mixes air with the dispensed liquid to create foam.

The pump mechanism is attached to a neck or other component of the reservoir so as to be in fluid communication with the contents of the reservoir. The reservoir may be initially filled with liquid through this connection point, with the pump mechanism being subsequently inserted into the reservoir. At the proper insertion location of the pump mechanism relative to the reservoir, a locking mechanism engages and locks the pump mechanism in position relative to the reservoir. The locking mechanism may also prevent subsequent removal of the pump mechanism from the reservoir. In a particular embodiment, the locking mechanism includes interengaging structure provided on the pump mechanism and the reservoir. For example, the interengaging structure may include a lug member on one component, and a complimentary shaped protrusion, recess, or other structure on the other component. The lug member is movable into or against the other structure upon initial placement of the pump mechanism onto the reservoir. In certain embodiments, engagement between the lug member and other structure may prevent subsequent removal of the pump mechanism without damaging the pump mechanism or reservoir.

The lug member may be provided on the pump mechanism. In a particular embodiment, the lug member is provided on an annular extension of the pump member that slides into a neck component of the reservoir. The protrusion, recess, or other complimentary engaging structure may be defined as an integral component of the reservoir, for example as a component molded directly into the reservoir. In one embodiment, one or more protrusions may be integrally molded into the neck component of the reservoir. Opposing protrusions may define an engagement recess between opposed facing walls, with the lug member slidable over one of the protrusions to enter the recess. The facing walls have a shape and size that prevents the lug member from being subsequently moved out of the recess. In an alternative embodiment, a single protrusion defines a rotational “stop” that engages the lug member and prevents further rotation or advancement of the pump mechanism relative to the reservoir.

In addition to the locking mechanism, a threaded engagement section may be provided between the pump mechanism and a neck on the reservoir upstream of the locking mechanism in a direction of initial advancement of the pump mechanism onto the neck such that the pump mechanism is threaded to the neck prior to actuation of the locking mechanism. In this embodiment, the locking mechanism allows threaded rotational advancement of the pump member relative to the neck to engage the locking mechanism, and may prevent the pump member from being rotated in the opposite direction in an attempt to unthread the pump member.

Aspects of the invention will be described in greater detail below with reference to embodiments shown in the figures.

### BRIEF DESCRIPTION OF THE DRAWINGS

FIG. 1 is a perspective view of a dispenser in accordance with the present invention.

FIG. 2 is a partial exploded view of the dispenser of FIG. 1 particularly illustrating the removable liquid reservoir.

FIG. 3 is a perspective view of a bottom surface of the replaceable liquid reservoir.

FIG. 4 is a perspective view of a suitable pump mechanism that may be mated with the removable liquid reservoir.

FIG. 5 is an end view of the pump mechanism engaged with the liquid reservoir.

### DETAILED DESCRIPTION

Reference is now made to particular embodiments of the inventive method and apparatus according to the invention, one or more examples of which are illustrated in the figures. It should be appreciated that the embodiments are provided by way of explanation of the invention, and are not meant as a limitation of the invention. For example, features illustrated or described with respect to one embodiment may be used in another embodiment to yield still a further embodiment. The present invention encompasses these and other modifications and variations made to the embodiments described and illustrated herein.

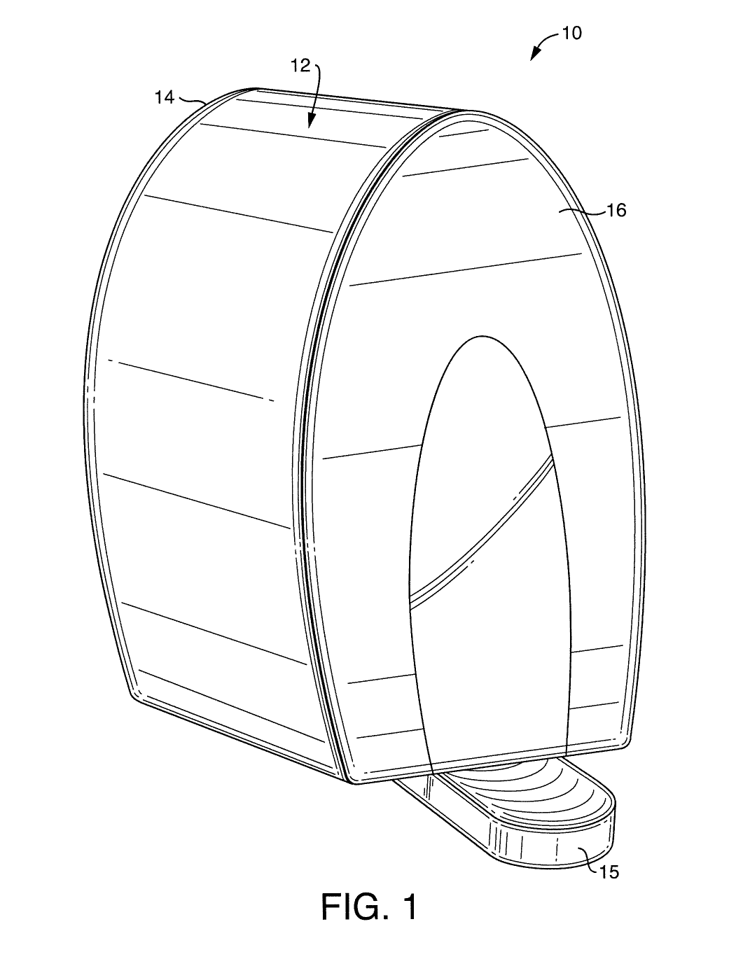

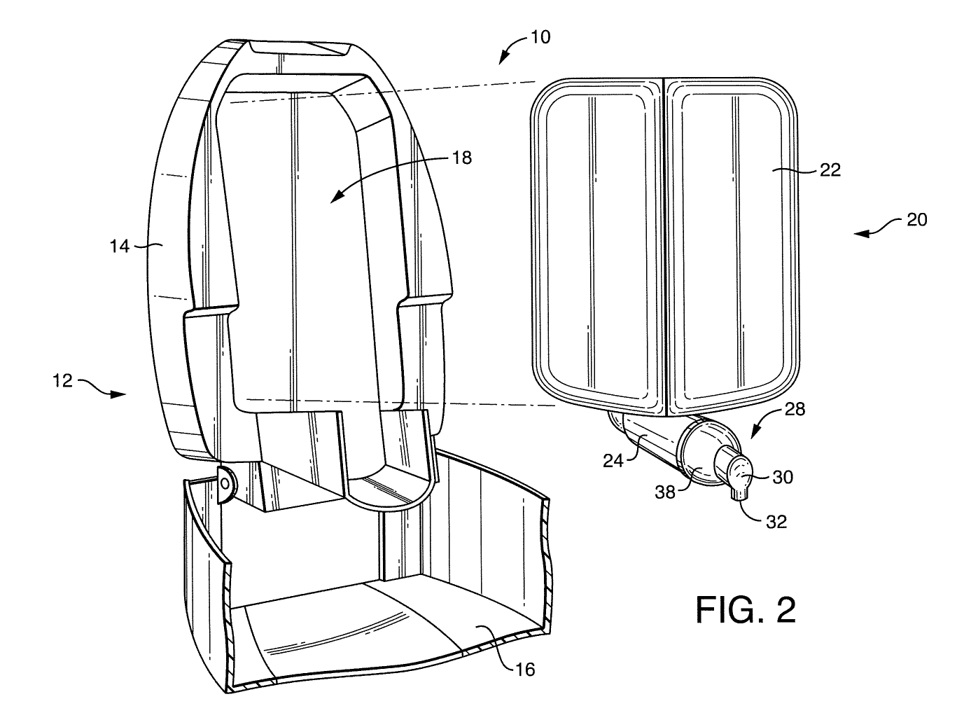

Referring to FIGS. 1 and 2, an embodiment of a dispenser 10 in accordance with the invention is illustrated. The dispenser 10 includes a housing 12 that may be of any desired shape, configuration, and appearance. In the illustrated embodiment, the housing 12 includes a back component 14 that is typically attached to a wall or other supporting surface utilizing any conventional attaching means. The housing 12 may include a front cover component 16 that is hinged to the back component 14, as illustrated in FIG. 2. An internal cavity 18 is provided within the housing 12 for receipt of a removable and replaceable liquid reservoir 20, as illustrated in FIG. 2.

The reservoir 20 may be any type of replaceable container or cartridge, for example a collapsible bag, a rigid wall container, a collapsible wall container, and so forth. The internal cavity 18 within the housing 12 has an appropriate size and configuration for secure receipt of the reservoir 20. In the illustrated embodiment, the reservoir 20 is an unvented container having flexible sidewalls 22. As liquid within the reservoir 20 is dispensed, the sidewalls 22 collapse inwards. With this type of reservoir 20, it is not necessary to provide a vent into the reservoir 20. However, it should be appreciated that the reservoir 20 may be a substantially rigid-walled vented container.

After the reservoir 20 has been depleted, the front cover component 16 is opened and the reservoir is removed from the housing 12, and may be disposed of or recycled. A full reservoir 20 is then inserted into the housing 12.

Referring to FIG. 2, a pump mechanism 28 is configured on the reservoir 20 in order to dispense metered doses of a liquid from the reservoir in the form of foam or a liquid. The housing 12 includes an actuating mechanism that interacts with the pump mechanism 28 once the reservoir 20 is seated within the housing 12 so that a user may actuate the pump mechanism 28. Referring to FIG. 1, the actuating mechanism may be any manner of lever 15, push-button, panel or the like. The actuating mechanism may be manual or electric, and may be a hands-free mechanism that senses the presence of the user and automatically dispenses the metered dose of liquid. Such actuating mechanisms are well known in the dispenser arts. It should be understood that the dispenser is not limited by the type of actuating mechanism configured between the pump mechanism 28 and housing 12.

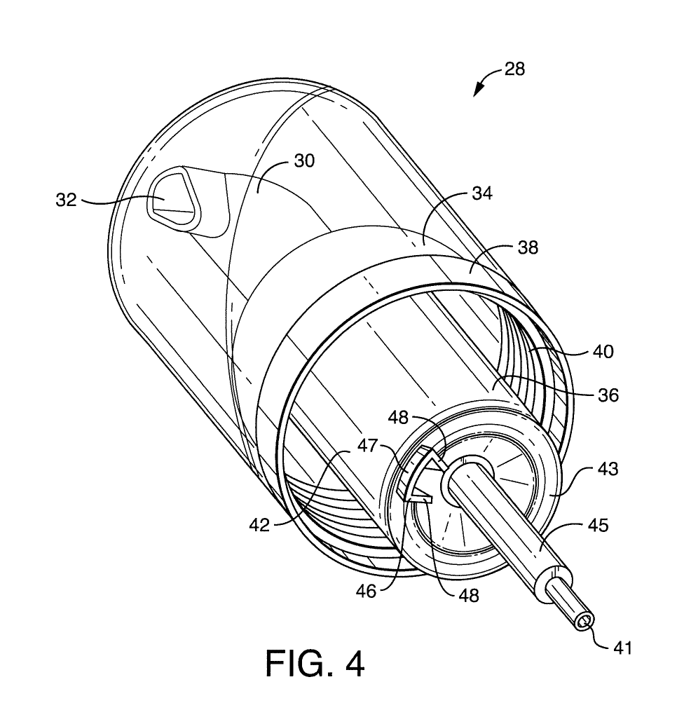

The pump mechanism 28 includes a pump body 36 that typically contains the internal working components of the pump. In the illustrated embodiment, a nozzle 30 defining a dispensing outlet 32 is engaged by the actuating mechanism 15 and depressed to actuate the pump mechanism. Referring to FIG. 4, a protective cap 34 may be provided over the nozzle 30 for sanitary, storage, or other reasons.

The pump mechanism 28 may be designed to dispense a metered dose of liquid from the reservoir 20, or may be a foaming pump configured to dispense a metered dose of foam, for example by mixing air with the dispensed liquid. The dispenser 10 is not limited to any particular type of pump mechanism 28, and various liquid and foaming pump mechanisms are well known and understood by those skilled in the art. A particularly well-suited foaming pump mechanism is identified as the M3 pump from Airspray NV of The Netherlands. Another example of a foaming pump is illustrated and described in U.S. Pat. No. 5,271,530, incorporated herein by reference in its entirety.

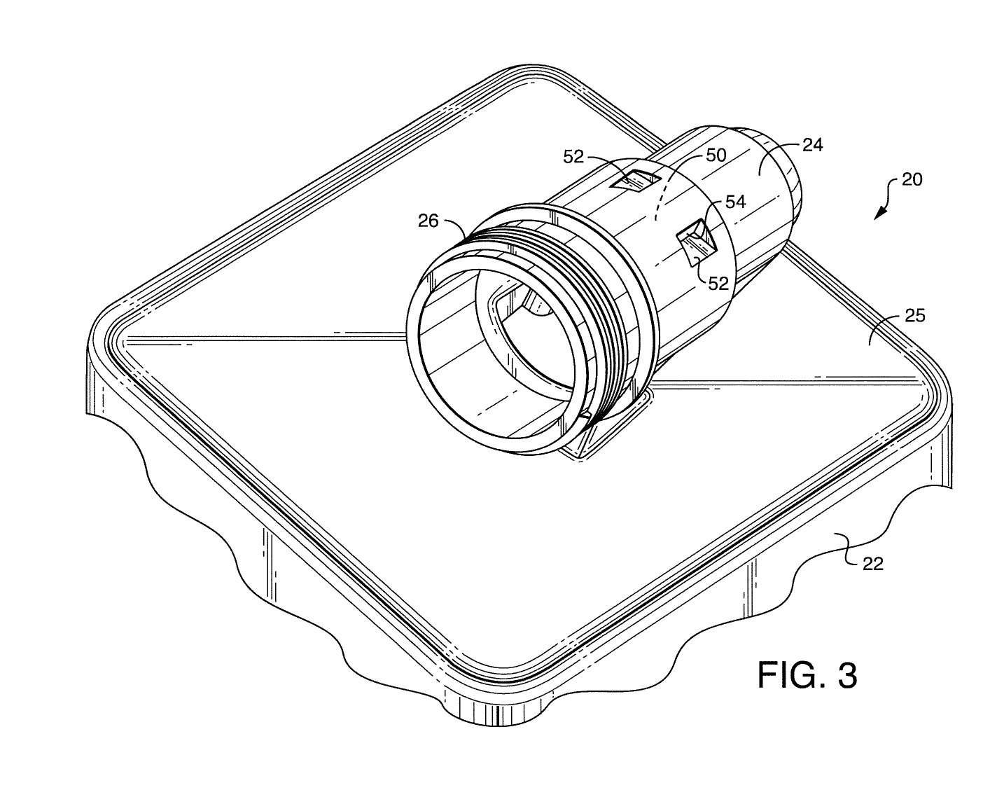

The pump mechanism 28 is attached to the reservoir 20 so as to be in communication with the liquid contained within the reservoir. In the illustrated embodiment, the pump mechanism 28 is attached to an elongated neck 24 provided on a bottom surface 25 of the reservoir 20, as particularly illustrated in FIG. 3. This neck 24 may include a threaded section 26 that engages with threads 40 (FIG. 4) defined within a shell member 38 of the pump mechanism 28. With this particular configuration, the pump mechanism 28 is threadedly advanced onto the neck 24 for initial placement of the mechanism 28 onto the reservoir 20. It should be appreciated that engagement between the pump mechanism 28 and reservoir 20, particularly the neck 24, is not limited to threaded engagement. Any conventional attaching interface between the components may be utilized. For example, a slide or friction fit interface between the components may be utilized.

Once properly inserted or otherwise attached to the reservoir 20, the pump mechanism 28 includes a suction tube 45 defining a suction inlet 41 that is in fluid communication with the internal contents of the reservoir. Depending on the orientation of the pump mechanism 28 with respect to the reservoir 20, an additional tube may be attached to the inlet 41 to extend to the bottom of the reservoir, particularly if the pump mechanism 28 is configured on a top surface of the reservoir 20. In the illustrated embodiment, the reservoir 20 is inverted when placed into the housing 12, as depicted in FIG. 2, such that the internal liquid contents of the reservoir drain into the neck 24. In this configuration, an additional suction tube is not necessary.

A locking mechanism, generally 44, is provided to engage and lock the pump mechanism 28 relative to the reservoir 20 at the proper insertion location and orientation of the pump mechanism relative to the reservoir. In a particular configuration, this locking mechanism also prevents subsequent removal of the pump mechanism 28 from the reservoir 20. The locking mechanism may take on various suitable configurations. In one embodiment, the locking mechanism comprises interengaging structure provided on the pump mechanism 28 and the reservoir 20 so that once the pump mechanism is inserted or otherwise engaged at a proper location on the reservoir 20, the interengaging structure engages and secures or “locks” the components in a relative position. The “locking” aspect of this engagement may also prevent subsequent removal of the pump mechanism.

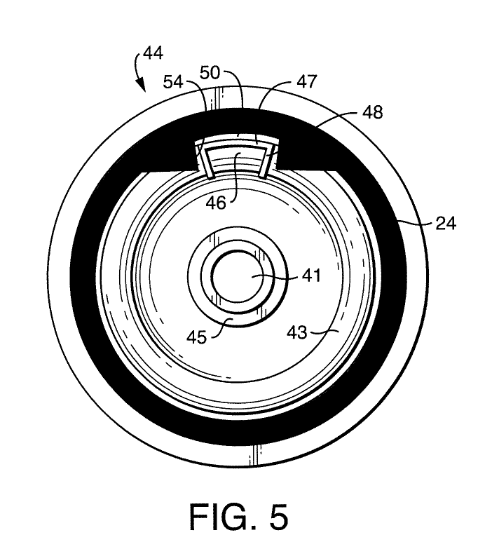

In an embodiment illustrated in the figures, the locking mechanism 44 includes interengaging structure provided on an annular extension 42 of the pump body 36 (FIG. 4) and complimentary structure provided within and formed integral with the elongated neck 24 in the bottom surface 25 of the reservoir 20 (FIG. 3). Referring to FIG. 3, the elongated neck 24 provides a convenient means for initially filling the reservoir 20 with any desired liquid. Once the reservoir has been filled, the pump mechanism 28 is threaded onto the neck 24 so that the annular extension 42 with suction tube 45 is inserted into the neck 24. Once the pump mechanism 28 has been threaded onto the neck 24, the locking mechanism 44 (FIG. 5) securely engages and locks the two components together so that the relative longitudinal and rotational position of the pump mechanism 28 is insured.

The locking mechanism 44 may include a lug member 46 on one component that engages with structure on the other component, such as a within a correspondingly shaped recess 50 or against a protrusion 52. The lug member 46 may be defined on either component, with the complimentary engaging structure defined on the other respective component. For example, referring to FIG. 4, the lug member 46 is provided on an end face 43 of the annular extension 42 in the pump mechanism 28. The lug member 46 may have any suitable shape or configuration. In a particular embodiment, the lug member 46 is defined by sidewalls 48 and an arcuate top surface 47. The sidewalls 48 have a radial aspect, as illustrated in the figures.

Referring to FIG. 3, the complimentary engagement structure is provided internally of the elongated neck 24, and may be defined as an integrally molded component or components of the neck. This structure may take on various shapes and configurations, and may include one or more inwardly oriented radial protrusions 52 molded directly into the neck. In the illustrated embodiment, two such rotrusions 52 define the recess 50 between facing walls 54 of the protrusions 52, as is readily seen in FIG. 5. The recess 50 has a shape and size so as to accommodate the lug 46 between the protrusions.

As explained below, the dual-protrusion 52 configuration of FIG. 5 also provides the locking mechanism 44 with the ability to prevent subsequent removal of the pump mechanism 28 from the neck 24. It should be appreciated, however, that a single protrusion 52 or similar structure is also within the scope of the invention. With a single protrusion 52, the protrusion is defined within the neck 24 to engage the lug 46 at a precise location to prevent further advancement of the pump mechanism 28 relative to the neck 24. The protrusion 52 thus defines a positional “stop” member, and may or may not prevent subsequent removal of the pump mechanism.

To attach the pump mechanism 28 onto the neck 24, the internal threads 40 of the pump shell 38 are engaged with the threads 26 on the neck 24 for initial advancement of the pump mechanism 28 relative to the neck 24. At the end of the threaded engagement between the components, the lug member 46 rotationally engages the protrusions 52. With the dual protrusion configuration of FIG. 5, the arcuate top surface 47 of the lug member 46 permits the lug member 46 to slide over the facing wall 54 with sufficient rotational torque applied to the pump mechanism 28. It may be desired that either the neck 24 or lug member 46 have some degree of “play” (e.g., expansion or compression of the respective materials) to accommodate movement of the lug member 46 into the recess 50. Once seated within the recess 50, the lug member 46 cannot be further rotationally advanced due to the radial shape and engagement of the lug sidewalls 48 and facing recess walls 54. Thus, the pump mechanism is maintained in a precise rotational and longitudinal orientation relative to the reservoir defined by the engaged position of the lug member 46 within the recess 50. Also, the pump mechanism 28 cannot be subsequently unthreaded from the reservoir 20 due to engagement between the lug member 46 and recess 50 without causing damage to the pump mechanism or reservoir.

With a single protrusion configuration, the protrusion 52 has an engagement face and shape to contact the lug member 46 and prevent any further rotational advancement of the pump mechanism. This single protrusion may be, for example, the downstream protrusion 52 in the embodiment of FIG. 5. In other words, the recess 50 defined between opposed protrusions is not present, and the lug member 46 does not slide over a first protrusion, but simply engages against a single protrusion 52.

It should be readily appreciated that different locking mechanism or interengaging configurations are possible within the scope and spirit of the invention to allow for initial attachment of the pump mechanism relative to the reservoir at a precise longitudinal and rotational position, with the locking mechanism then locking the two components at this position and desirably preventing subsequent removal of the pump mechanism from the reservoir.

It should be further understood that modifications and variations may be made to the embodiments of the dispenser illustrated and described herein without departing from the scope and spirit of the invention. It is intended that the invention include these and other modifications as come within the scope and spirit of the appended claims.

What is claimed is:

1. A dispenser for dispensing a metered dose of foam or liquid from a reservoir, comprising:
a housing;
a replaceable liquid reservoir seated within said housing;
a pump mechanism attached to said reservoir, said pump mechanism further comprising a dispensing nozzle oriented to dispense the metered dose from said reservoir upon actuation of said dispenser by a user;
said pump mechanism attached to said reservoir with a locking mechanism configured to engage and lock said pump mechanism at a desired position relative to said reservoir and to prevent subsequent removal of said pump mechanism from said reservoir.

2. The dispenser as in claim 1, wherein said locking mechanism comprises interengaging structure provided on said pump mechanism and said reservoir, said interengaging structure disposed so as to engage when said pump mechanism has been advanced to the desired final attachment position relative to said reservoir.

3. The dispenser as in claim 2, wherein said locking mechanism comprises a lug member and complimentary shaped recess, said lug member movable into said recess upon initial placement of said pump mechanism onto said reservoir, said lug member being non-removable from said recess after the initial placement of the pump mechanism.

4. The dispenser as in claim 3, wherein said lug member is provided on an annular extension of said pump member that slides into an open neck on said reservoir, said recess defined in said neck.

5. The dispenser as in claim 3, wherein said recess is defined between facing inner walls of opposed protrusions, at least one of said protrusions having an outer surface over which said lug member slides to engage within said recess, said inner walls having a shape that prevents said lug member from sliding out of said recess.

6. The dispenser as in claim 5, wherein said recess in defined within an open neck on said reservoir, and said lug member is defined on an annular extension of said pump member that slides into said neck.

7. The dispenser as in claim 1, further comprising a threaded engagement section between said pump mechanism and an open neck on said reservoir upstream of said locking mechanism in a direction of initial advancement of said pump mechanism onto said neck such that said pump mechanism is threaded to said neck prior to actuation of said locking mechanism.

8. The dispenser as in claim 7, wherein said locking mechanism allows threaded rotational advancement of said pump member relative to said neck, and prevents opposite rotational movement of said pump member relative to said neck.

9. The dispenser as in claim 8, wherein said locking mechanism comprises interengaging structure provided on said pump mechanism and said neck, said interengaging structure disposed so as to rotationally engage when said pump mechanism has been threaded onto said neck to the desired relative position onto said neck.

10. The dispenser as in claim 9, wherein said locking mechanism comprises a lug member and complimentary shaped recess, said lug member rotationally movable into said recess upon initial threaded placement of said pump mechanism onto said neck, said recess preventing opposite rotational movement of said lug member to prevent said pump mechanism from being unthreaded from said neck.

11. The dispenser as in claim 10, wherein said lug member is provided on an annular extension of said pump member, said threaded engagement section comprises threads on said annular extension upstream of said lug member.

12. The dispenser as in claim 11, wherein said recess is defined between facing inner walls of opposed protrusions within said neck, at least one of said protrusions having an outer surface over which said lug member rotationally slides to engage within said recess, said inner walls having a shape that prevents opposite rotational movement of said lug member to prevent said pump mechanism from being unthreaded from said neck.

13. A dispenser for dispensing a metered dose of foam or liquid from a reservoir, comprising:
a housing;
a replaceable liquid reservoir seated within said housing;
a pump mechanism threadedly engaged to a neck of said reservoir, said pump mechanism further comprising a dispensing nozzle oriented to dispense the metered dose from said reservoir upon actuation of said dispenser by a user;
a rotational locking mechanism configured to engage and lock said pump mechanism at a desired threaded position relative to said neck so as to prevent further threaded advancement of said pump mechanism and to prevent unthreading of said pump mechanism from said neck.

14. The dispenser as in claim 13, wherein said locking mechanism comprises a lug member and complimentary shaped recess, said lug member movable into said recess upon initial threaded advancement of said pump mechanism onto said neck, thereafter said lug member being non-removable from said recess and preventing further rotation of said pump mechanism in any direction.

15. The dispenser as in claim 14, wherein said recess is defined between facing inner walls of opposed protrusions that extend into said neck, said lug member disposed on an annular extension of said pump member that fits into said neck, at least one of said protrusions having an outer surface over which said lug member rotationally slides to engage within said recess, said inner walls having a shape that prevents said lug member from sliding out of said recess.

16. A dispenser for dispensing a metered dose of foam or liquid from a reservoir, comprising:
a housing;
a replaceable liquid reservoir seated within said housing, said reservoir comprising an elongated neck;
a pump mechanism attached to said reservoir, said pump mechanism further comprising a dispensing nozzle oriented to dispense the metered dose from said reservoir upon actuation of said dispenser by a user;
said pump mechanism attached to said reservoir with a locking mechanism configured to engage and lock said pump mechanism at a desired position relative to said reservoir, said locking mechanism comprising interengaging structure provided on said pump mechanism and integrally formed within said neck in so as to engage when said pump mechanism has been advanced into said neck to the desired final attachment location and angular position relative to said reservoir.

17. The dispenser as in claim 16, wherein said locking mechanism comprises a lug member on an annular extension of said pump member that slides into said neck, and complimentary shaped engaging structure integrally molded into said neck.

18. The dispenser as in claim 17, wherein said engaging structure molded into said neck comprises a first radially inwardly oriented protrusion having a size and shape to engage and prevent said lug member and prevent further advancement of said pump mechanism into said neck.

19. The dispenser as in claim 18, wherein said engaging structure comprises an additional radially inwardly oriented protrusion opposed to said first protrusion such that a recess is defined between facing inner walls of said opposed protrusions, said lug member received in said recess and said additional protrusion preventing removal of said pump mechanism from said neck.

20. The dispenser as in claim 18, further comprising a threaded engagement section between said pump mechanism and said neck upstream of said locking mechanism in a direction of initial advancement of said pump mechanism onto said neck such that said pump mechanism is threaded to said neck prior to actuation of said locking mechanism, said first protrusion preventing further threaded rotational advancement of said pump member upon engaging said lug member.
